(19) United States
(12) Patent Application Publication
(10) Pub. No.: US 2017/0080687 A1
(43) Pub. Date: Mar. 23, 2017

(54) ENERGY-EFFICIENT FENESTRATION SUBSTRATE AND METHOD OF MANUFACTURING THE SAME

(71) Applicant: Clear Wall Corporation, Vacaville, CA (US)

(72) Inventor: Normand Marchand, Vacaville, CA (US)

(21) Appl. No.: 15/311,791

(22) PCT Filed: May 16, 2014
(86) PCT No.: PCT/US2014/038511

§ 371 Date: Nov. 16, 2016

(51) Int. Cl. B32B 15/20; B32B 9/00; B32B 15/04; E06B 5/20; B32B 27/36; B32B 37/12; E06B 3/28; B32B 7/12; B32B 27/30

(52) U.S. Cl. CPC B32B 15/20; B32B 7/12; B32B 9/005; B32B 15/04; B32B 27/302; B32B 27/36; B32B 37/12; E06B 3/285; E06B 5/205; B32B 2307/302; B32B 2307/412; B32B 2307/414; B32B 2419/00

(57) ABSTRACT

A roll of energy-efficient laminate substrate is described. The energy-efficient fenestration assembly includes: (1) a performance film having at least one energy-efficient property; (2) a supporting film mechanically supporting said performance film; and (3) wherein said performance film is laminated and rolled with said supporting film to form said roll of said laminate energy-efficient substrate.

### FIELD OF THE INVENTION

The present invention relates generally to substrate structures for energy efficiency applications. More particularly, the present invention relates to laminate energy-efficient substrates, fenestration assemblies incorporating the laminate substrates, methods of fabricating the laminate substrates and methods of making a room energy-efficient.

### BACKGROUND OF THE INVENTION

Fenestration refers to products that fill openings in a building envelope, such as windows, doors, skylights, curtain walls, etc. These products are designed to permit the passage of air, light, vehicles, or people. A building envelope, in turn, generally refers to the separation between the interior and the exterior environments of a building. As such, the building envelope serves as an outer shell that both protects and facilitates climate control of the indoor environment.

During daylight hours, people typically draw blinds to reduce or eliminate the glare caused by the sunlight piercing through a window. This blocks a substantial portion of the view from the window, and thereby defeats the purpose of having a window in the first place. As a result, there has been an effort to modify a window by directly applying on it a glare-reducing film (hereinafter referred to as “a film on glass configuration”) that is transparent enough to not obscure the view through the window.

A film on glass configuration reflects a certain amount of light (e.g., sun light) impinging upon the film on glass configuration. During summer season, greater reflection of light keeps out greater amount of heat associated with that light from the building's interior and allows cooler temperatures to prevail inside the building envelope.

Similarly, a certain amount of heat that is contained in an interior of a building envelope reflects back by a film on glass configuration. During winter season, greater reflection of heat allows a greater amount of heat retention inside the building's interior and allows for warmer temperature to prevail inside the building envelope.

Unfortunately, conventional substrates suffer from drawbacks. Specifically, the amount of light and heat that is reflected from conventional substrates does not rise to the desired high levels to be considered energy efficient. In fact, the conventional films absorb a greater than desired amount of light impinging upon it or greater than desired amount of heat contained inside the building envelope.

What are therefore needed are energy-efficient substrate structures and methods of making the same.

### SUMMARY OF THE INVENTIONS

In response to this need, the present invention provides inventive laminate energy-efficient substrates, which in preferred embodiments provides a certain distance between a laminate substrate and a window. In other words, it is not necessary to directly apply a substrate to a window, as it is in conventional film on glass configurations. The distance between the window and the laminate substrate serves to increase thermal-efficient properties through inventive fenestration assemblies. As a result, heat that is absorbed by the inventive fenestration assemblies is transferred in or out of the building envelope at a much slower rate, making the inventive assemblies significantly more energy efficient.

In view of the foregoing, one aspect of the present arrangements provides a roll of laminate energy-efficient substrate. The roll includes: (i) a performance film having at least one energy-efficient property; (ii) a supporting film mechanically supporting the performance film; and (iii) wherein the performance film is laminated and rolled with the supporting film to form the roll of the laminate energy-efficient substrate.

In one embodiment of the present arrangements, at least one of the energy-efficient property of performance film is chosen from a group including thermal resistivity, total solar transmittance, solar heat gain coefficient, air infiltration and emissivity. For example the performance film may have a thermal resistivity that ranges from about 0.015 W/m²K to about 0.35 W/m²K and/or have a total solar transmittance that ranges from about 30% of the total sunlight incident on the performance film to about 85% of the total sunlight incident on the performance film.

In certain embodiments of the present arrangements, the performance film includes at least one material chosen from a group including polyester, metal, UV inhibitor, ceramic and carbon. In this embodiment, the metal may include at least one material chosen from a group including silver, copper, gold, aluminum and stainless steel.

In one embodiment of the present arrangements, the surface of the performance film and/or the supporting film that faces the window or room is a washable surface.

In certain embodiments of the present arrangements, each of the performance film and the supporting film has a thickness that is between about 1.5 mils and about 15 mils. In other embodiments of the present arrangements, the performance film or the supporting film reduces transmission of acoustic propagation.

In yet another embodiment of the present arrangements, the supporting film includes a polymer matrix having a transparency that is between about 1% of the light incident on the supporting film and about 99% of the light incident on the supporting film.

In according with one embodiment of the present arrangements, the roll may further include one or more intermediate films being disposed between the performance film and the supporting film, and one or more of the intermediate films include at least one type of film chosen from a group comprising performance film, adhesive layer, adhesive film and aesthetic film.

In another embodiment of the present arrangements, the roll may further include a liner that is applied to a surface of the laminated energy-efficient substrate to prevent substantial contact and adhesion between portions of a non-laminated surface of the performance film and portions of a non-laminated surface of the supporting film in the roll. In yet another embodiment of the present arrangements, the roll may be disposed on a roller.

In another aspect, the present arrangements provide an energy-efficient fenestration assembly comprising: (i) a laminate energy-efficient substrate; (ii) a frame including a window-side surface and a room-side surface, which is opposite to the window-side surface, and the room-side surface substantially surrounding and having secured thereon the laminate energy-efficient substrate, and a distance between the room-side surface and the window-side surface defines a thickness of the frame such that when the frame is installed adjacent to a window, the thickness of the frame provides a space between the laminate energy-efficient substrate and the window; and (iii) wherein the laminate energy efficient substrate includes at least two films, at least one of which is a performance film that is designed to reduce exchange of energy between an inside and outside of a room and another of the films mechanically supports the performance film.

In certain embodiments of the present arrangements, the energy-efficient fenestration assembly the frame is made from one material chosen from a group comprising wood, vinyl, polystyrene and metal.

In some embodiments of the present arrangement, the energy-efficient fenestration assembly further includes a segment having a surface that engages and/or mates with the room-side surface of the frame such that the laminate energy-efficient substrate is secured between the frame and the segment.

In another embodiment of the present arrangements, the energy-efficient fenestration assembly further includes an adhesive that secures the laminate energy-efficient substrate to the room-side surface of the frame.

In yet another aspect, the present teachings provide a method of making a roll of an energy-efficient substrate. The method of making a roll includes: (i) obtaining a performance film with at least one energy-efficient property; (ii) obtaining a supporting film that supports the performance film; (iii) laminating the supporting film and the performance film to form an energy-efficient substrate; and (iv) rolling the energy-efficient substrate to form the roll of the energy-efficiency substrate.

In certain embodiments of the present teachings, the method of making a roll further includes obtaining one or more intermediate films, and wherein the laminating includes laminating one or more of the intermediate films with the supporting film and the performance film, and wherein the one or more of the intermediate films are disposed between the supporting film and the performance film.

In other embodiments of the present teachings, the method of making a roll further includes applying a liner to a surface of the energy-efficient substrate prior to the rolling of the energy-efficient substrate.

In some embodiments of the present teachings, obtaining the performance film includes obtaining a piece of the performance film from a roll of the performance film and obtaining the supporting film includes obtaining a piece of the supporting film from a roll of the supporting film. Laminating may be carried out by applying heat and/or applying adhesives.

In yet another aspect, the present teachings proved a method of making another energy-efficient fenestration assembly. The method of making an energy-efficient fenestration assembly includes: (i) obtaining a roll of laminate energy-efficient substrate; (ii) obtaining a frame including a room-side surface and window-side surface, and the room-side surface faces towards a room when the window-side surface of the frame is installed adjacent to a window inside the room; (iii) unrolling and removing a piece from the roll of laminate energy-efficient substrate to form a piece of laminate energy-efficient substrate; and (iv) adhering the piece of laminate energy-efficient substrate to the room-side surface of the frame to form the energy-efficient fenestration assembly. Adhering may include applying adhesive or applying one or more segments that engage and/or mate with the frame when the energy-efficient substrate is secured on the frame.

In yet another aspect, the present teachings provide a method of making a room energy-efficient. The method of making a room energy-efficient includes: (1) obtaining a roll of laminate energy-efficient substrate; (2) obtaining a frame including a room-side surface and window-side surface, and when the window-side surface of the frame is installed adjacent to a window inside a room, the room-side surface faces towards the room; (3) unrolling and removing a piece from the roll of laminate energy-efficient substrate to form a piece of laminate energy-efficient substrate; (4) adhering the piece of laminate energy-efficient substrate to the room-side surface of the frame to form the energy-efficient fenestration assembly; and (5) installing the window-side surface of the frame adjacent to the window of the room to reduce amount of energy exchange between inside and outside of the room.

In certain embodiments of the present teachings, installing includes using a compressible material disposed around the frame to secure the frame around a window cavity that includes the window.

### BRIEF DESCRIPTION OF THE DRAWINGS

FIG. 1 shows a perspective view of a portion of a manufacturing system, according to one embodiment of the present arrangements, for manufacturing present laminate energy-efficient substrates.

FIG. 2 shows a perspective view of a roll of energy-efficient substrates, according to one embodiment of the present arrangements.

FIG. 3 shows a front view of a fenestration assembly, according to one embodiment of the present arrangements and that has incorporated into it a piece of laminate energy-efficient substrate obtained from the roll shown in FIG. 2.

FIG. 4 shows a side-sectional view of the fenestration assembly shown in FIG. 3.

FIG. 5 shows a side-sectional view of another fenestration assembly, according to another embodiment of the present arrangements, that is similar to the fenestration assembly of FIG. 4, except fenestration assembly of FIG. 5 includes one or more adhesive layers disposed inside an laminate energy-efficient substrate (e.g., roll of energy-efficient substrate of FIG. 2).

FIG. 6 shows a side-sectional view of yet another fenestration assembly, according to yet another embodiment of the present arrangements and that includes an intermediate film inside the laminate energy-efficient substrate (e.g., roll of energy-efficient substrate of FIG. 2).

FIG. 7 shows a side-sectional view of an installed configuration, according to one embodiment of the present arrangements, of a fenestration assembly (e.g., fenestration assembly of FIG. 4) adjacent to a window.

FIG. 8 shows a method, according to one embodiment of the present teachings, of fabricating a roll of laminate energy-efficient substrate (e.g., roll of laminate energy-efficient substrate of FIG. 2).

### DETAILED DESCRIPTION OF THE PREFERRED EMBODIMENTS

In the following description, numerous specific details are set forth in order to provide a thorough understanding of the present teachings and arrangements. It will be apparent, however, to one skilled in the art that the present teachings and arrangements may be practiced without limitation to some or all of these specific details. In other instances, well known process steps have not been described in detail in order to not unnecessarily obscure the present teachings and arrangements.

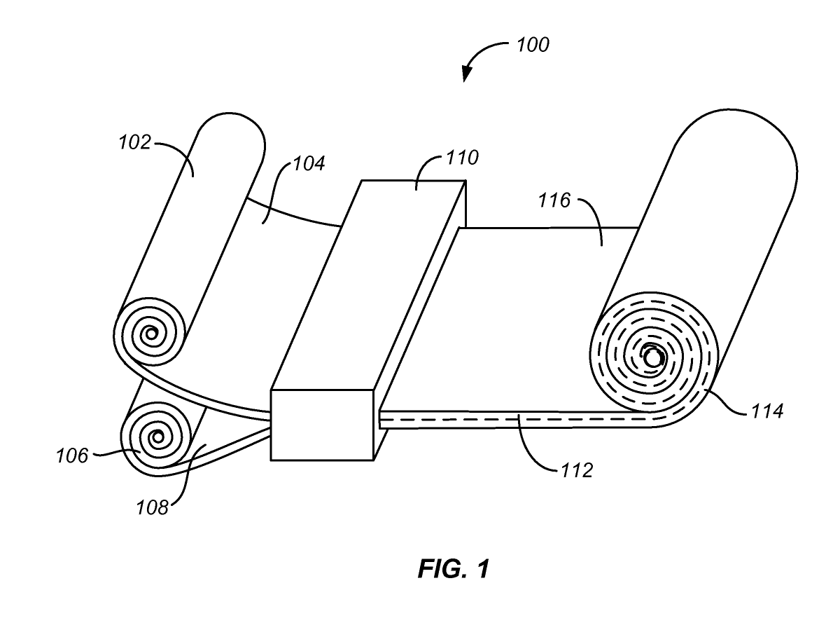

FIG. 1 shows a portion of a manufacturing system 100, according to one embodiment of the present arrangements, for fabricating a roll of present laminate energy-efficient substrates. Manufacturing system 100 includes a laminator 110, which laminates two or more films obtained from at least two different rolls, e.g., a performance film roll 102 and a supporting film roll 106. A performance film roll 102 feeds a performance film 104 into laminator 110 and supporting film roll 106 feeds a supporting film 108 into the same laminator 110. Performance film 104 and supporting film 108 undergo lamination inside laminator 110 to form a laminate energy-efficient substrate 112 (hereinafter referred to as a “laminate substrate”). A take-up roll located downstream from laminator 110 is used to package in roll form laminate substrate 112 and form a roll of laminate substrate 114. In some instances, roll of laminate substrate 114 is rolled onto roller (e.g., a cylindrical cardboard tube) to provide stability during transportation and storage.

In another embodiment of the present arrangements, a roll of liner (e.g., paper) dispenses a liner material (not shown to simplify illustration) adjacent to laminate substrate 112 so that the ultimately produced roll of laminate substrate 114 includes the liner material integrated with the laminate substrate 112. In a rolled up form, the liner material contacts portion of both surfaces of laminate substrate 112. In this configuration, the liner material substantially reduces or prevents undesired adhesion between non-laminated surface 116 of performance film 104 and non-laminated surface of supporting layer 108. Such undesired adhesion may occur when they are presented in a roll form (e.g., roll of laminate substrate 114 of FIG. 1). As a result, in the absence of the liner material, and in light of the adhering tendencies of non-laminated surfaces of performance film 104 and supporting layer 108, the component films, e.g., performance film 104 and supporting film 108, may roll up at angle, resulting in a roll of laminate substrate that suffers from non-uniform width and that detrimentally impacts the subsequent fabricating step. Although the liner material is not a necessary component of roll of laminate substrate 114, it represents a preferred embodiment of the present arrangement.

Laminator 110 is any laminating machine. However, any model chosen from AGL 8000 Series and preferably AGL 8000R, commercially available from Advanced Greig Laminator, Inc. of Deforest, Wis., works well.

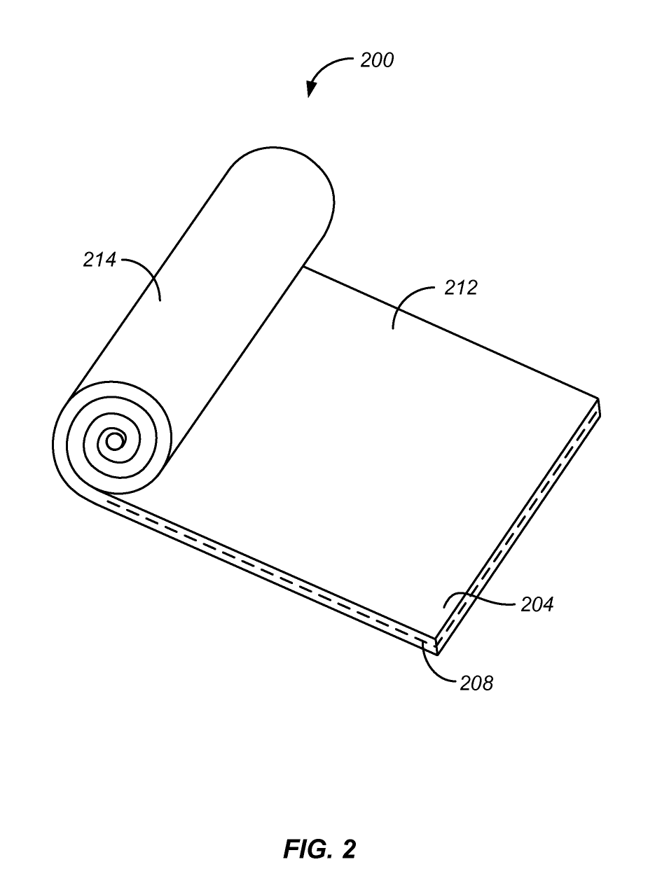

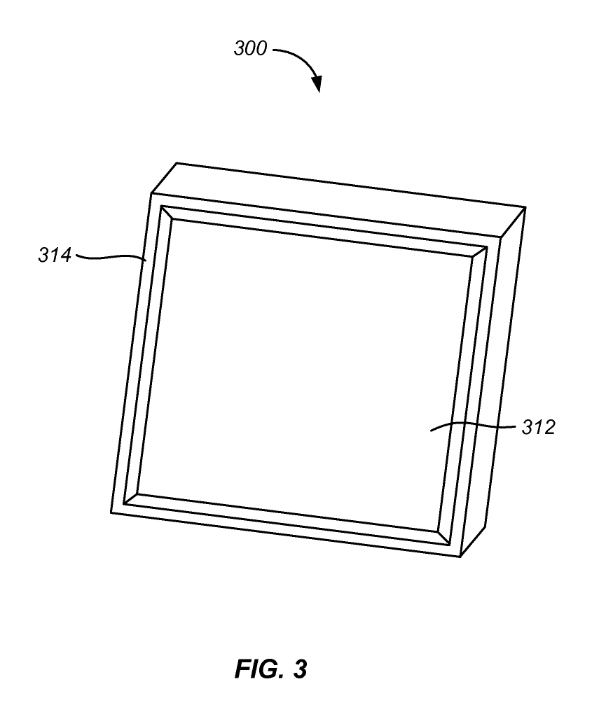

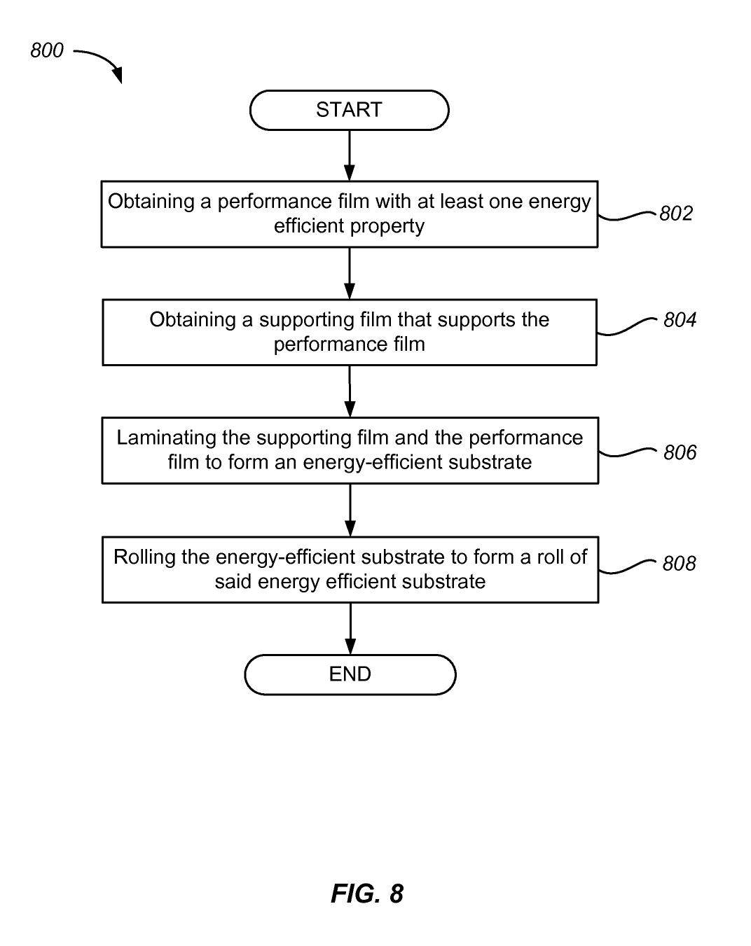

FIG. 2 shows a production-ready roll of energy-efficient substrate in a rolled out state 200, according to one embodiment of the present arrangements and that may be used in the fabrication of present fenestration assemblies (e.g., fenestration assembly 300 of FIG. 3). In rolled out state 200, a roll of laminate substrate 214 dispenses portions of a laminate substrate 212, which includes two or more component films, e.g., performance film 204 and supporting film 208, which are similar to their counterparts, e.g., performance film 104 and supporting film 108 of FIG. 1. As a result, roll of laminate substrate 214 is substantially similar to roll of laminate substrate 114, except laminate substrate 114 is produced using a fabricating process (e.g., process 800 of FIG. 8), according to one embodiment of the present teachings and laminate substrate 214 is used in a subsequent fabricating process as described below.

The present teachings recognize that roll of laminate substrate 214 is easily and quickly stored and transported from one location to another, setting the stage to effect an inexpensive and high throughput fabrication process that uses energy-efficient substrates to manufacture energy-efficient products. Against a backdrop where energy-efficient technologies or products are not seen as commercially viable because they frequently require high capital expenditures, and may involve time-consuming and arduous fabricating techniques, the present fabricating energy-efficient substrates in a roll form overcome many such drawbacks and represent a significant improvement over conventional techniques. According to the present teachings, fenestration assemblies (e.g., fenestration assembly 300 of FIG. 3) are one example of energy-efficiency products that are made from the present energy-efficient substrates.

FIG. 3 shows a fenestration assembly 300, according to one embodiment of the present arrangements. Fenestration assembly 300 may be thought of as a cartridge that attaches to a window or is disposed inside a window frame. According to FIG. 3, fenestration assembly 300 includes a laminated substrate 312 disposed on a frame 314. Laminate substrate 312 includes a performance film and a supporting film (both are not shown to simplify illustration) that are substantially similar to performance film 204 and supporting film 208 of FIG. 2.

Frame 314 may be made from any rigid material that is sturdy enough to support laminate substrate 312, which may be flexible but relatively thick compared to a single layer of substrate material. By way of example, frame 314 is made from at least one material selected from a group comprising wood, vinyl, polystyrene and metal. Embodiments of the present arrangements, in which the frame is made from metal or aluminum, are preferred as they are sufficiently sturdy and relatively inexpensive to manufacture.

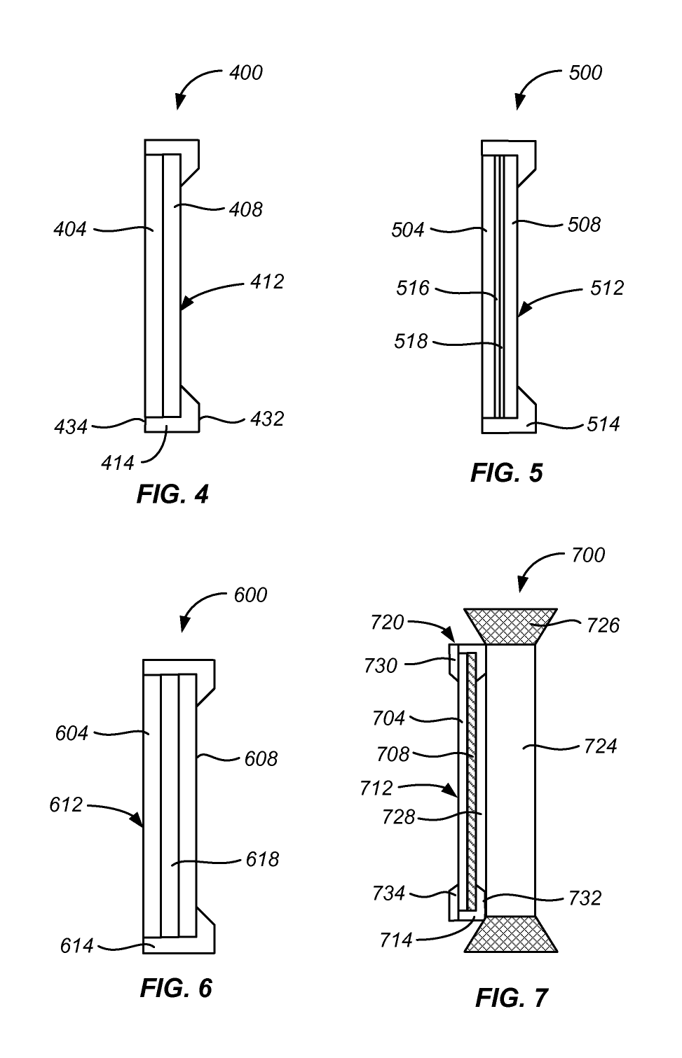

FIG. 4 shows a fenestration assembly 400, according to one embodiment of the present arrangements and that represents a side-sectional view of fenestration assembly 300 of FIG. 3. In the embodiment shown in FIG. 4, frame 414 includes a window-side surface 432, which is adjacent to a window when fenestration assembly 400 is installed adjacent to the window. Room-side surface 434, which is opposite window-side surface 432, substantially surrounds and secures laminate substrate 412 to frame 414. When installed adjacent to a window, room-side surface 434 faces a room or an interior of a building envelope.

In another embodiment of the present arrangement, laminate substrate 412 is secured to room-side surface of frame 414 using a securing mechanism (e.g., segment 734 of FIG. 7) and/or an adhesive.

Frame 414, laminate substrate 412, performance film 404 and supporting film 408 are substantially similar to frame 314 and laminate substrate 312 of FIG. 3, and performance film 204 and supporting film 208 of FIG. 2, respectively. Unrolling and removing a piece of a roll of laminate substrate (e.g., roll of laminate substrate 214 of FIG. 2) provides a piece of laminate substrate 412.

Performance film 404 is any film having energy-efficiency properties, i.e., properties that reduce energy exchange between inside and outside of a room. By way of example, performance film reduces thermal resistivity. Thermal resistivity is the ability of energy, in the form of heat, to travel through a material. A building may absorb energy (e.g., radiant energy from the sun) and transfer the energy, in the form of heat, from the exterior of the building envelope, through the building envelope, and ultimately to an interior of the building envelope (e.g., inside a room). Similarly, the interior of a building envelope can absorb energy from the interior of the building (e.g., inside a room) and transfer the energy in heat form to the exterior of the building. Therefore, performance film 404, as part of the fenestration assembly inside the building envelope, may be any material that reduces the ability of heat to travel through performance film 404.

Performance film 404 may be made from at least one material chosen from a group comprising of polyester, metal, UV inhibitor, ceramic and carbon. In one preferred embodiment of the present arrangements, performance film 404 includes a metal (e.g., silver, copper, gold, aluminum and stainless steel) dispersed in a polymer matrix. In this embodiment, the metal reflects radiant energy away from performance film 404 and also reduces the amount of radiant energy absorbed by performance film 404. In another embodiment of the present arrangements, a coating applied to a surface of performance film 404 imparts performance film 404 with its energy-efficient properties.

Supporting film 408 may be any film that provides mechanical support to and increases the longevity of performance film 404. Mechanical support allows fenestration assembly 400, including performance film 404 to effectively withstand the forces encountered during transportation, installation, removal and cleaning. Supporting film 408 protects performance film 404 from external forces, such as those applied by humans, windows shades and/or blinds.

In one embodiment of the present arrangement, supporting film 408 allows light to pass through it. Consequently, supporting film 408 may be translucent or transparent. In certain embodiments of the present arrangement, supporting film 408 is substantially similar to performance film 404. In certain of these embodiments, the two films, i.e., performance film 404 and supporting film 408, are of the same type, but may be of the same or different thicknesses. In accordance with one embodiment of the present arrangement, each of performance film 404 and supporting film 408 generally have a thickness that is between about 1.5 mils and about 15 mils, and preferably have a thickness that is between about 2 mils and about 12 mils. Performance film 404 and supporting film 408 laminated together form laminate substrate 412 that is not too thin to be flimsy, and under tension, has a window-like appearance. In addition, it is not too thick so that it is difficult to mount on frame 414, and difficult to adapt and/or conform to the structure of frame 414.

In one embodiment of the present arrangements, laminated substrate 412 may have a scratch-resistant coating on at least one of its surfaces, and preferably on both of its surfaces, making the substrate surface(s) washable, without damaging laminating substrate 412. In other words, surfaces of laminated substrate 412 may be washed without leaving water stains or streaks. Thus, laminate substrate 412 maintains a glass-like appearance through its lifetime.

FIG. 5 shows another fenestration assembly 500, according to another embodiment of the present arrangements. Fenestration assembly 500 includes performance film 504, supporting film 508, laminate substrate 512 and frame 514 that are substantially similar to their counterparts performance film 404, supporting film 408, laminate substrate 412 and frame 414 as shown and described in connection with FIG. 4. Fenestration assembly 500 may also include one or more adhesive layers between performance film 504 and supporting film 508. FIG. 5 shows two adhesive layers 516 and 518 disposed between performance film 504 and supporting film 508. Commercially available films may include an adhesive coating, with a protective adhesive liner on one side of the film such that when the protective adhesive liner is removed, the film is directly applied to a window to form a conventional film on glass configuration. Examples of such commercially available films are Silver 35, which is commercially available from 3M Corporation of Minneapolis, Minn. and V Kool, which is commercially available from V Kool, Houston, Tex. To form laminate substrate 512, it is preferable that the adhesive layers of one or both films are positioned between the film layers, e.g., performance film 504 and supporting film 508. In this manner, the adhesive layer is on the inside between performance film 504 and supporting film 508 rather than on either of its exposed sides. If performance film 504 and/or supporting film 508 have a protective adhesive liner, it should be removed before performance film 504 and supporting film 508 are fed into the laminator (e.g., laminator 110 of FIG. 1) to form laminate substrate 512.

FIG. 6 shows a yet another fenestration assembly 600, according to yet another embodiment of the present arrangements. Fenestration assembly 600 includes performance film 604, supporting film 608, laminate substrate 612 and frame 614 that are substantially similar to performance film 404, supporting film 408, laminate substrate 412 and frame 414 of FIG. 4. Fenestration assembly 600 includes an intermediate layer 618 disposed between performance film 604 and supporting film 608. In one embodiment of the present fenestration assemblies, there may be multiple intermediate layers. In those instances where one or more intermediate layers are used, at least some of the intermediate layers are substantially similar to performance film 604 and/or supporting film 608. For example, in one embodiment of the present arrangements, intermediate layer 618 may be an additional layer of performance film 604 that contributes to the thermal-efficient properties of fenestration assembly 600. Similarly, intermediate layer 618 may be an additional layer of supporting film 608 to provide additional mechanical support to laminate substrate 612.

In other embodiments of the present arrangements, intermediate layer 618 is neither performance film 604 nor supporting film 608. As a result, intermediate layer 618 may be any material that provides additional properties desired by fenestration assembly 600. For example, intermediate layer 618 may include a dye to change the color of laminate substrate 612.

FIG. 7 shows a configuration 700, according to one embodiment of the present arrangements and that includes an exemplar fenestration assembly 720 installed adjacent to a window 724. Fenestration assembly 720 includes performance film 704, supporting film 708, laminate substrate 712 and frame 714 are substantially similar to their counterparts performance film 404, supporting film 408, laminate substrate 412 and frame 414 of FIG. 4. In addition, segment 734 secures laminate substrate 712 to room-side surface 734 of frame 714. In configuration 700, performance film 704 is positioned room side and supporting film 708 faces window 724. The present teachings are not so limited, and another configuration, where the supporting film 708 is positioned room side and performance film 704 faces window 724, is also possible.

As shown in the embodiment of FIG. 7, fenestration assembly 720 is sized according to the dimensions of window 724. Specifically, laminate substrate 712 and frame 714 combine to provide fenestration assembly 720 with an appropriate height to cover a glass portion of window 724. Fenestration assembly 720 does not cover the entire or any part of frame 726. Rather, a compressible material (e.g., foam or rubber), disposed around the external surface of frame 714, may secure fenestration assembly 720 to window frame 720. However, it is not necessary for fenestration assembly 720 to be sized according to the dimensions of window 724. In another embodiment of the present arrangements, fenestration assembly 720 is sized according to the dimensions of frame 726. In this manner, laminate substrate 712 and frame 714 combine to provide fenestration assembly 720 with an appropriate height to cover the glass portion of window 724 and frame 726.

Regardless of whether fenestration assembly 720 is sized to window 724 or frame 726, in the attached position the distance between room-side surface 734 and the window-side surface 732 define a thickness of the frame such that laminate substrate 712 and window 724 create a dead air space. Dead air space 728 is a gap between fenestration assembly 720 and window 724 that is filled with air and reduces heat transfer through window assembly 700. As a result, fenestration assembly 720 includes two mechanisms (e.g., performance film 704 and dead air space 728) that together provide greater energy-efficiency characteristics (e.g., thermal resistivity, total solar transmittance, solar heat gain coefficient, air infiltration and emissivity) than a film on glass configuration, i.e., where there is not dead space, between the substrate and the glass of the window, and that the substrate is directly applied to the window.

Thermal resistivity, also known as U-value, refers to a measurement used to determine the ability of different structural components (such as films or windows) to conduct heat. It is expressed in watts per meters squared kelvin, or W/m²K. A well-insulated structural component has a lower U-value, whereas a poorly insulated structural component has a higher U-value. In one embodiment of the present arrangements, performance film has a thermal resistivity that ranges from about 0.015 W/m²K to about 0.35 W/m²K.

In on embodiment of the present arrangements, window assembly 700 reduces the total solar transmittance through window assembly 700. Total Solar Transmittance refers to the percentage of total solar radiation (e.g., infrared, visible and ultraviolet energy) that passes though a structural component. In one embodiment of the present arrangements, performance film has a total solar transmittance between about 30% to about 85%.

In addition, laminate substrate 712 of fenestration assembly 720 installed in configuration 700 may provide additional benefits, such as reduced air infiltration and increased acoustic performance. Air infiltration refers to the amount of air that enters room side or into a building envelope through the various windows, doors and fenestration assemblies, if any, installed in a building envelope. Acoustic performance refers to the amount of sound transmitted through the various windows, doors and fenestration assemblies, if any, installed in a building envelope.

The present teachings also offer novel methods of making a roll of energy-efficient laminate substrate (e.g., 114 of FIG. 1 and 214 of FIG. 2). FIG. 8 shows a method 800, according to one embodiment of the present teachings, for making a roll of laminate substrate. Method 800 preferably begins with a step 802, which includes obtaining a performance film (e.g., performance film 104 of FIG. 1) with energy efficient properties, such as effecting reduction of thermal resistivity. Performance film may be obtained in various forms. In one embodiment of the present arrangements, performance film may be obtained from a roll of performance film to facilitate continuous and high-throughput manufacturing of laminate substrate. In another embodiment of the present arrangements, performance film may be obtained as single sheets. Furthermore, performance film may have an adhesive surface and/or one or more coating layers.

Next, a step 804 includes obtaining a supporting film that in a subsequent step is disposed adjacent to the performance film, to provide the performance film with mechanical support and to form a mechanically stable energy-efficient laminate substrate. Similar to performance film, supporting film may be obtained in various forms. In one embodiment of the present arrangements, supporting film may be obtained from a roll of supporting film to facilitate continuous, high-throughput manufacturing of laminate substrate. In another embodiment of the present arrangements, supporting film may be obtained as single sheets. Also, supporting film may include an adhesive surface and/or one or more coating layers.

Process 800 then proceeds to a step 806, which includes laminating the supporting film adjacent to the performance film to form a laminate energy-efficient substrate. In one embodiment of the present arrangements, laminating is carried out using a laminator described in connection with FIG. 1. A step 808 next includes rolling the laminate substrate to form a roll of a laminate substrate that is energy-efficient.

The present teachings contemplate other embodiments of processes for fabricating a roll of laminate substrate. In one embodiment of the present teachings, the process of fabricating the roll of laminate substrate includes disposing a liner (e.g., a sheet of paper) adjacent to a non-laminate surface (e.g., non-laminate surface 116 of FIG. 1) of the laminate substrate and rolling the liner with the substrate to form the roll of laminate substrate. As the liner is rolled up with the laminate substrate, the liner contacts both surfaces of the laminate substrate. Thus, the liner prevents the laminate substrate from sticking to itself as it is rolled up. As explained above, this forms a roll and, during a subsequent fabricating step, dispenses pieces of a laminate substrate of substantially uniform width. The width of the laminated substrate may have a slight variation, so long as it effectively facilitates fabrication of fenestration assemblies of the present arrangements.

In another embodiment of the present teachings, the process of fabricating the roll of laminate substrate includes obtaining and incorporating one or more intermediate layers, as discussed in connection with FIG. 6, between the performance film and the supporting film.

The present processes of fabricating an energy-efficient laminate substrate in the form of a roll have many advantages. By way of example, producing a roll of laminate substrate may be carried out as a continuous process, without any stops in production. In contrast, if laminate substrate is manufactured in the form of sheets, the fabrication process is typically carried out in batch mode and is not continuous, as it requires frequent stops to cut, move and store the sheets. Thus, fabricating the laminate substrate in the form of a roll, as opposed to in sheets, offers a significant advantage. As another example, in roll form, a large amount of the laminate substrate is easily transported for subsequent fabrication of fenestration assemblies. As yet another example, during this fabrication process, laminate substrate is continuously dispensed from the roll so that it may be continuously used to fabricate fenestration assemblies. Thus, various energy-efficient technologies that are conventionally not deemed commercially viable because of, among other things, the high capital and operating expenditures associated with them, become viable when using the present teachings.

Although illustrative embodiments of the present teachings and arrangements have been shown and described, other modifications, changes, and substitutions are intended. Accordingly, it is appropriate that the appended claims be construed broadly and in a manner consistent with the scope of the disclosure, as set forth in the following claims.

What is claimed is:

1. A roll of a laminate energy-efficient substrate, said roll comprising:
a performance film having at least one energy-efficient property;
a supporting film mechanically supporting said performance film; and
wherein said performance film is laminated and rolled with said supporting film to form said roll of said laminate energy-efficient substrate.

2. The roll of claim 1, wherein at least one of said energy-efficient property is chosen from the group comprising thermal resistivity, total solar transmittance, solar heat gain coefficient, air infiltration and emissivity.

3. The roll of claim 1, further comprising one or More intermediate films being disposed between said performance film and said supporting film, and one or more of said intermediate films include at least one type of film chosen from a group comprising said performance film, said supporting film, another performance film having a different energy efficient property from said performance film, another supporting film, an adhesive layer, adhesive film and aesthetic film.

4. The roll of claim 1, further comprising a liner that is applied to a surface of said laminated energy-efficient substrate to prevent substantial contact and adhesion between portions of a non-laminated surface of said performance film and portions of a non-laminated surface of said supporting film in said roll.

5. (canceled)

6. The roll of claim 1, wherein said performance film has a thermal resistivity that ranges from about 0.015 W/m²K to about 0.35 W/m²K.

7. The roll of claim 1, wherein said performance film has a total solar transmittance that ranges from about 30% of the total sunlight incident on said performance film to about 85% of the total sunlight incident on said performance film.

8. The roll of claim 1, wherein a surface of said performance film that faces said window or room is a washable surface and a surface of said supporting film that faces said window or room is a washable surface.

9. The roll of claim 1, wherein said performance film includes at least one material chosen from a group comprising polyester, metal, UV inhibitor, ceramic and carbon.

10. The roll of claim 9, wherein said metal includes at least one material chosen from a group comprising silver, copper, gold, aluminum and stainless steel.

11. The roll of claim 1, wherein each of said performance film and said supporting film has a thickness that is between about 1.5 mils and about 15 mils.

12. The roll of claim 1, wherein said supporting film includes a polymer matrix that has a transparency that is between about 1% of the light incident on said supporting film and about 99% of the light incident on said supporting film.

13. The roll of claim 1, wherein said performance film or said supporting film reduce transmission of acoustic propagation.

14. An energy-efficient fenestration assembly comprising:
a laminate energy-efficient substrate;
a frame including a window-side surface and a room-side surface, which is opposite to said window-side surface, and said room-side surface substantially surrounding and having secured thereon said laminate energy-efficient substrate, and a distance between said room-side surface and said window-side surface defines a thickness of said frame such that when said frame is installed adjacent to a window, said thickness of said frame provides a space between said laminate energy-efficient substrate and said window; and
wherein said laminate energy efficient substrate includes at least two films, at least one of which is a performance film that is designed to reduce exchange of energy between an inside and outside of a room and another of said films mechanically supports said performance film.

15. The energy-efficient fenestration assembly of claim 14, further comprising a segment having a surface that engages and/or mates with said room-side surface of said frame such that said laminate energy-efficient substrate is secured between said frame and segment.

16. The energy-efficient fenestration assembly of claim 14, further comprising an adhesive that secures said laminate energy-efficient substrate to said room-side surface of said frame.

17. The energy-efficient fenestration assembly of claim 14, wherein said frame is made from one material chosen from a group comprising wood, vinyl, polystyrene and metal.

18. (canceled)

19. (canceled)

20. (canceled)

21. (canceled)

22. (canceled)

23. A method of making an energy-efficient fenestration assembly comprising:
obtaining a roll of laminate energy-efficient substrate;
obtaining a frame including a room-side surface and window-side surface, and said room-side surface faces towards a room when said window-side surface of said frame is installed adjacent to a window inside said room;
unrolling and removing a piece from said roll of laminate energy-efficient substrate to form a piece of laminate energy-efficient substrate; and
adhering said piece of laminate energy-efficient substrate to said room-side surface of said frame to form said energy-efficient fenestration assembly.

24. The method of claim 23, wherein said adhering includes applying adhesive or applying one or more segments that engage and/or mate with said frame when said energy-efficient substrate is secured on said frame.

25. (canceled)

27. (canceled)
